(19) United States
(12) Patent Application Publication
(10) Pub. No.: US 2014/0371929 A1
(43) Pub. Date: Dec. 18, 2014

(54) Source Impedance Estimation

(71) Applicant: Schweitzer Engineering Laboratories, Inc., Pullman, WA (US)

(72) Inventors: William F. Allen, Airdrie (CA); Dennis Haes, Colfax, WA (US)

(21) Appl. No.: 13/919,487

(22) Filed: Jun. 17, 2013

(51) Int. Cl. G05B 15/02

(52) U.S. Cl. CPC G05B 15/02
USPC 700/286

(57) ABSTRACT

Disclosed herein are a variety of systems and methods for estimating a source impedance value. One embodiment may include an intelligent electronic device (IED) configured to interface with an electric power distribution system. The IED may include a communications interface, a processor, and a non-transitory computer-readable storage medium. The computer-readable storage medium may include software instructions executable on the processor that enable the IED to identify a source impedance modeling event at a node in the power distribution system. The software instructions may further enable the IED to receive a plurality of measurements representing an electrical condition at the node prior to the source impedance modeling event and subsequent to the source impedance modeling event. The IED may calculate a source impedance value based on the first plurality of measurements at the node. Based on the source impedance value, a control action may be generated.

### TECHNICAL FIELD

The present disclosure relates to systems and methods for obtaining and refining an estimate of a source impedance value and/or creating a source impedance model based on measurements of source impedance modeling events in an electric power distribution system. More specifically, but not exclusively, the present disclosure relates to estimating equivalent source impedance values and creating a source impedance model at different nodes in an electric power distribution system. The source impedance model may be used to dynamically predict the effects of control actions on electrical conditions thereby informing the selection of control actions to achieve a control objective.

### BRIEF DESCRIPTION OF THE DRAWINGS

Non-limiting and non-exhaustive embodiments of the disclosure are described herein, including various embodiments of the disclosure with reference to the figures, in which:

FIG. 1A illustrates a simplified one-line diagram of an electric power distribution system consistent with certain embodiments disclosed herein.

FIG. 1B illustrates in vector format a plurality of electrical parameters associated with FIG. 1A.

FIG. 2 illustrates a simplified one-line diagram of an electric power distribution system having a plurality of voltage measurement devices consistent with certain embodiments disclosed herein.

FIG. 3 illustrates a flow chart of one embodiment of a method for estimating a source impedance value and creating a source impedance model based on data collected in connection with one or more source impedance modeling events.

FIG. 4 illustrates an exemplary block diagram of an intelligent electronic device configured to collect electrical measurements and to generate a source impedance value and create a source impedance model based on data collected in connection with one or more source impedance modeling events.

### DETAILED DESCRIPTION

Electric power distribution systems may include electric power generation, transmission, and distribution equipment and loads that consume electric power. For example, such systems include various types of equipment such as generators, transformers, circuit breakers, switches, distribution lines, transmission lines, buses, capacitor banks, reactors, loads, and the like. Electric power generation sites may be located at significant distances from an end user or load. Generated electric power is typically at a relatively low voltage, but is transformed into a relatively high voltage before entering a transmission system. The voltage is again reduced for the delivery system, and often reduced yet again before ultimate delivery to the end user or load. The electric power may be monitored and controlled at various stages in the delivery system. Intelligent electronic devices (IEDs) are often used to collect electric power system information, make control and/or protection decisions, implement control, automation, and/or protection actions, and/or monitor the electric power distribution system.

Various embodiments disclosed herein relate to systems and methods for calculating a source impedance value and/or creating a source impedance model and associated parameters (e.g., tunable parameters) that may be used to predict a source impedance under a variety of conditions and/or at a variety of locations in an electric power distribution system. Based on a predicted source impedance value or a simulation involving a source impedance model, optimized control strategies may be employed in the management of the electric power distribution system.

Any action that causes a disruption to the electric power distribution system (e.g., a change in voltage or frequency) may provide information regarding the composition or dynamics of the electric power distribution system. Such information may include the impedance of one or more sources. Actions that cause disruption in the electric power distribution system may be referred to as modeling events, or when used in the context of determining source impedance, source impedance modeling events. Source impedance modeling events may include, but are not limited to, connecting a reactive power source to the electric power distribution system, adjusting a tap setting in a voltage regulator, detecting a phase shift among phases in a multi-phase power system, etc.

Reactive power sourcing devices, including but not limited to capacitors, are commonly used in an electric power distribution systems to compensate for the reactive component of load current, and by extension improve power factor and reduce voltage drop. Fixed or switched capacitors may be installed at one or more locations in an electric power system. Switched capacitors may be controlled based on a variety of criteria including time of day, current, voltage, voltage-time, voltage-current, temperature, manual control, etc. Many strategies rely on local measurements and local actions; however, system-level objectives may be better achieved by coordinated control actions involving multiple devices in the electric power system.

A voltage profile of an electrical circuit may include the variations in voltage magnitude along the circuit. A plurality of voltage measurements may be made at various locations along the circuit and may allow the voltage profile of the circuit to be monitored by one or more IEDs or other control systems. The voltage profile may be manipulated using multiple devices in electrical communication with the circuit, including voltage regulators and capacitors. Many system-level objectives involve the manipulation of the circuit voltage profile, either as a primary objective or as an interrelated consequence of a primary objective. Examples of such system-level objectives include energy conservation, peak demand reduction, and loss reduction.

A voltage drop on a circuit (e.g., a transmission line) may be due to the impedance of the circuit. A capacitor may be added to a circuit near a load to supply reactive current, which may decrease the reactive component of current supplied from the source. A reduction in the reactive component may result in a decrease in the voltage drop along the circuit.

A variety of types of equipment deployed across an electric power distribution system may provide data that may be utilized in generating an estimate of a source impedance value and/or creating a source impedance model. Devices that control the voltage and/or frequency in an electric power distribution system may be utilized in conjunction with devices that measure various electrical parameters in the electric power distribution system to obtain data from which a source impedance value and/or creating a source impedance model may be derived. Communication among these devices may allow an IED or other device to identify a source impedance modeling event. Time synchronization of measured data and control instructions resulting in modeling events may facilitate identification of source impedance modeling events.

Source impedance models are mathematical functions that may be used to describe the source impedance as a function of various parameters in an electric power distribution system. A variety of types of source impedance models may be provided, each of which may include several parameters that, in certain embodiments, may include tunable parameters. The tunable parameters may be refined over time to more accurately predict a response of a physical system under a variety of conditions. The term source impedance model, as used herein, refers to both a source impedance model and the tunable parameters within the source impedance model. The tunable parameters and the selected source impedance model may influence the accuracy of the predictions made using the source impedance models. More advanced models may provide more accurate results, but may require greater computational resources and/or time to solve. Simplified models may require less time and/or resources, but may provide less accurate results.

Predictive modeling techniques may be employed to plan (e.g., automatically plan) a sequence of coordinated actions. Models of an electric power distribution system, including source impedance models, may be static or dynamic in nature. Static models may require detailed impedance data to be known; however, the power distribution system may change over time due to operational objectives and capital projects. Such changes may result in degraded accuracy of the static model. Dynamic models may attempt to characterize the power system and improve the characterization over time. This disclosure may be used in connection with dynamic or static models. In connection with embodiments utilizing dynamic models, various aspects of the present disclosure may be used to predict voltage responses along an electrical circuit to the switching of reactive power sourcing apparatus.

The embodiments of the disclosure will be best understood by reference to the drawings, wherein like parts are designated by like numerals. The components of the disclosed embodiments, as generally described and illustrated in the figures herein, may be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. In some cases, well-known features, structures or operations are not shown or described in detail. Furthermore, the described features, structures, or operations may be combined in any suitable manner in one or more embodiments.

Several aspects of the embodiments described herein include software modules or components. A software module or component may include any type of computer instruction or computer executable code located within a memory device and/or transmitted as electronic signals over a system bus, a wired network, or a wireless network. A software module or component may, for instance, comprise one or more physical or logical blocks of computer instructions, which may be organized as a routine, program, object, component, data structure, etc., which performs one or more tasks or implements particular abstract data types.

In certain embodiments, a particular software module or component may comprise disparate instructions stored in different locations of a memory device, which together implement the described functionality of the module. A module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable and/or computer-readable medium having stored thereon instructions that may be used to program a computer (or other electronic device) to perform processes described herein. The medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

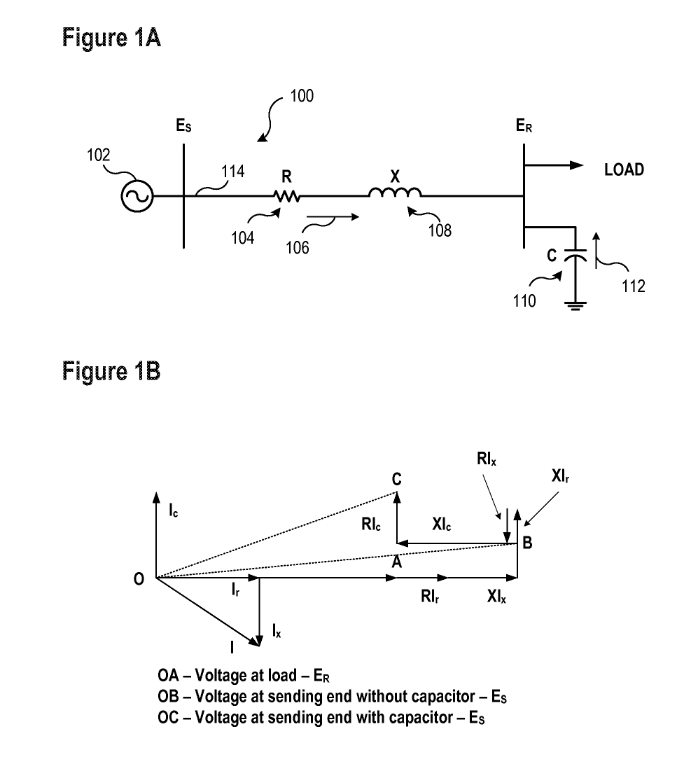

FIG. 1A illustrates a simplified one-line diagram of an electric power distribution system 100 consistent with certain embodiments disclosed herein. System 100 includes a source 102 in communication with a transmission line 114. Transmission line 114 may exhibit a resistance 104 and an inductance 108. Further, the inductive component of a load in the system 100 may also influence the inductance 108. System 100 may provide electrical energy generated by source 102 to a load, which results in a flow of current 106 through transmission line 114. System 100 may further include a capacitor 110 that may be selectively coupled to system 100 in order to provide reactive power support. A current 112 may flow through capacitor 110 when capacitor 110 is connected to system 100.

FIG. 1B illustrates in vector format a plurality of electrical parameters associated with FIG. 1A. Current 106 is represented in FIG. 1B as /, and current 112 is represented as I_{C}. As illustrated in FIG. 1 B, the voltage at the sending end, E_{S}, has a larger imaginary component when capacitor 110 is not connected to system 100 in comparison to the imaginary component when capacitor 110 is connected to system 100. Specifically, the voltage at the sending end where capacitor 110 is not connected to system 100 is shown in FIG. 1B as \vec{OB}, where the voltage at the sending end where capacitor 110 is connected to system 100 is shown in FIG. 1B as \vec{OC}. The reduction in the imaginary component, or reactive power component, may result in improved power utilization. When capacitor 110 is connected to system 100, the source voltage magnitude may be reduced due to the effect of XI_{C}.

According to one embodiment, the voltage drop between E_{S} and E_{R} without capacitor 110 may be approximated as using Eq. 1.

Voltage Drop≈R*I_{R}+X*I_{X} Eq. 1

In Eq. 1, I_{R} is the current flowing through resistor 104, R is the value of resistor 104, I_{X} is the current flowing through inductor 108, and X is the value of inductor 108.

Where capacitor 110 is connected to system 100, the voltage drop between E_{S} and E_{R} may be approximated using Eq. 2.

Voltage Drop≈R* I_{R}+X*I_{X}−X*I_{c} Eq. 2

In Eq. 2, I_{c} is the current flowing through capacitor 110.

In comparing Eq. 1 and Eq. 2, it may be noted that the difference in the voltage drop, ΔV, is approximately equal to the current contribution from the capacitor multiplied by the reactance (X) between the source and the voltage measurement location, as expressed in Eq. 3.

ΔV=X*I_{c} Eq. 3

The current contribution from the capacitor, I_{c}, is related to the reactive power ratings of the capacitor, Q_{rated}, and the present voltage, Vₗₗ, at the terminals of the capacitor, as expressed in Eq. 4.

$${I}_{C} = \frac{{Q}_{rated}}{\sqrt{3} * {V}_{ll}} \qquad Eq . 4$$

Combining equations 3 and 4 and solving for X gives the result in Eq. 5.

$$X = \frac{\sqrt{3} * {V}_{ll}}{{Q}_{rated}} * Δ V \qquad Eq . 5$$

The change in voltage, ΔV, due to connecting capacitor 110 to system 100 may be calculated based on measured voltage before and after connecting capacitor 110 to system 100. Moreover, a plurality of voltage measurements may be taken at various locations between capacitor 110 and source 102. The line-to-line voltage (e.g., the voltage difference between two phases of a three phase circuit)may also be measured. Measurement of the line-to-line voltage may be significant because the line-to-line voltage may effect the magnitude of I_{C}. According to one embodiment, the line-to neutral voltage may be measumented and Eq. 4 and Eq. 5 may be modified to express a relationship in terms of the line-to-neutral measurement. Alternately, certain embodiments may utilize the rated voltage of system 100 and neglect the effect of terminal voltage variations on the magnitude of I_{C}.

Using the plurality of voltage measurements and Eq. 5, a source impedance value may be calculated at each measurement location.

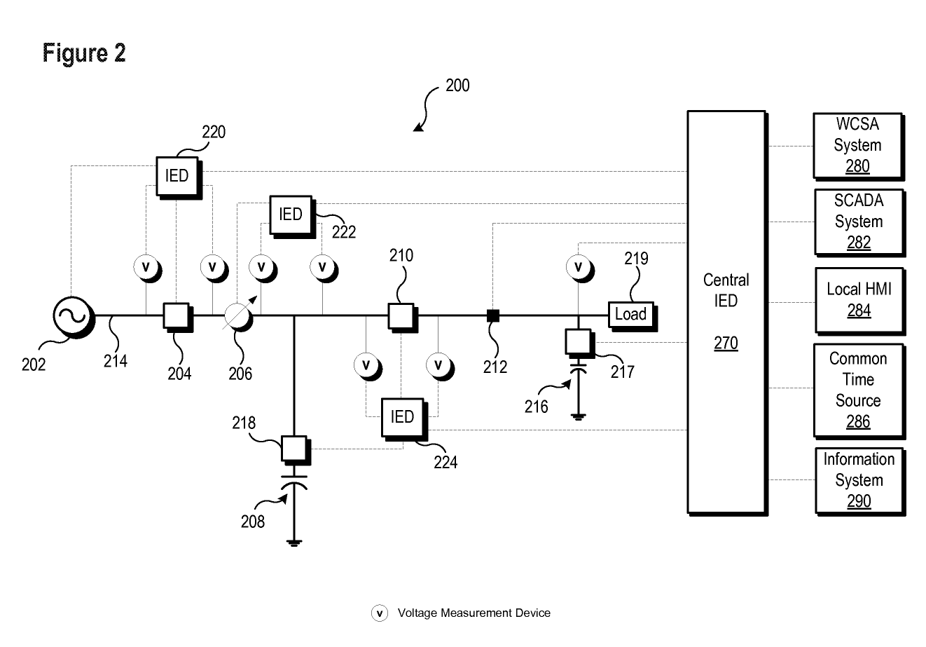

FIG. 2 illustrates a simplified one-line diagram of an electric power distribution system 200 having a plurality of voltage measurement devices consistent with certain embodiments disclosed herein. System 200 is provided for illustrative purposes and does not imply any specific arrangements or functions required of any particular IED. In some embodiments, IEDs 220, 222, 224, and 270 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. Further, IEDs 220, 222, 224, and 270 may be configured to communicate calculations, such as phasors (which may or may not be synchronized as synchrophasors). IEDs 220, 222, 224, and 270 may also communicate settings information, IED identification information, communications information, status information, alarm information, and the like.

In certain embodiments, IEDs 220, 222, 224, and 270 may issue control instructions to monitored equipment in order to control various aspects relating to the monitored equipment. For example, an IED (e.g., IED 220) may be in communication with a breaker (e.g., breaker 204), and may be capable of sending an instruction to open and/or close the breaker, thus connecting or disconnecting a portion of system 200. In another example, an IED may be in communication with a recloser and capable of controlling reclosing operations. In yet another example, an IED may be in communication with a voltage regulator and capable of instructing the voltage regulator to tap up and/or down. Information of the types listed above, or more generally, information or instructions directing an IED or other device to perform a certain action, may be referred to as control instructions.

A data communications network among IEDs 220, 222, 224, and 270, which is shown using dashed lines, may utilize a variety of network technologies, and may comprise network devices such as modems, routers, firewalls, virtual private networks, servers, and the like, which are not shown in FIG. 2. The data communications network may operate using a variety of physical media, such as coaxial cable, twisted pair, fiber optic, etc. Further, the data communications network may utilize communication protocols such as Ethernet, TCP/IP, SONET, SDH, or the like, to communicate data. In further embodiments, the data communications network may include one or more wireless communication channels (e.g., a radio communication channel, a microwave communication channel, the satellite communication channel) utilizing any suitable wireless communication protocol.

The various IEDs in system 200 may obtain electric power information from monitored equipment using potential transformers (PTs) for voltage measurements, current transformers (CTs) for current measurements, and the like. The PTs and CTs may include any device capable of providing outputs that can be used by the IEDs to make potential and current measurements, and may include traditional PTs and CTs, optical PTs and CTs, Rogowski coils, hall-effect sensors, and the like.

According to embodiment illustrated in FIG. 2, a source 202 may be in communication with a transmission line 214. A breaker 204 may be configured to selectively isolate source 202 from the remainder of system 200. An IED 220 may be in communication with breaker 204, and may selectively actuate breaker 204 based on conditions in system 200. IED 220 may receive voltage measurements from two associated voltage measurement devices, although other suitable configurations are also contemplated.

A voltage regulator 206 may be in communication with the transmission line 214. Voltage regulator 206 may be configured to selectively increase or decrease in output voltage based upon instructions received from IED 222. The voltage regulator 206 may include a plurality of taps associated with a transformer that permits adjustment of the output of voltage regulator 206. In addition to communicating with voltage regulator 206, IED 222 may also receive voltage measurements from two associated voltage measurement devices.

A capacitor 208 may be selectively coupled to system 200 by actuation of a breaker 218. As illustrated, breaker 218 may be in communication with IED 224. Capacitor 208 may be selectively coupled to system 200 in order to provide reactive power support under appropriate conditions. IED 224 may further communicate with breaker 210 and two associated voltage measurement devices.

Each of IEDs 220, 222, and 224 may be in communication with a central IED 270. IEDs 220, 222, and 224 may communicate information received from voltage measurement devices and other equipment to central IED 270. System-level coordinated control instructions may be generated by central IED 270 and communicated to IEDs 220, 222, and 224 for implementation. According to some embodiments, control actions may also be generated by IEDs 220, 222, and 224, and such control actions may be transmitted to central IED 270 so that such actions may be incorporated into a system-level control strategy.

In addition to communicating with IEDs 220, 222, and 224, central IED 270 may also be in communication with a number of other devices or systems. Such devices or systems may include, for example, a WCSA system 280, SCADA system 282, a local Human-Machine Interface (HMI) 284, a common time source 286 and an information system 290. Local HMI 284 may be used to change settings, issue control instructions, retrieve an event report, retrieve data, and the like. In some embodiments, WCSA system 280 may receive and process time-aligned data, and may coordinate time synchronized control actions at the highest level of the electric power distribution system 200.

Common time source 286 may provide a time input or a time signal that may be used by central IED 270 for time stamping information and data. Time synchronization may be used for data organization, real-time decision-making, as well as post-event analysis. Time synchronization may further be applied to network communications. Common time source 286 may be any time source that is an acceptable form of time synchronization, including, but not limited to, a voltage controlled temperature compensated crystal oscillator, Rubidium and Cesium oscillators with or without digital phase locked loops, microelectromechanical systems (MEMS) technology, which transfers the resonant circuits from the electronic to the mechanical domains, or a GPS receiver with time decoding. In the absence of a common time source available to all IEDs, central IED 270 may serve as a common time source by distributing a time synchronization signal.

Information system 290 may include hardware and software to enable network communication, network security, user administration, Internet and intranet administration, remote network access and the like. Information system 290 may generate information about the network to maintain and sustain a reliable, quality, and secure communications network by running real-time business logic on network security events, perform network diagnostics, optimize network performance, and the like.

In addition to interacting with IEDs 220, 222, and 224, and higher level systems, central IED 270 may also be in communication with monitored equipment, such as a voltage sensing device 212, a breaker 217 and a voltage measurement device. The term voltage sensing device refers to any device configured to measure a voltage, regardless the way in which such measurements are acquired. Breaker 217 may selectively couple capacitor 216 to system 200 in order to provide reactive power support.

Source impedance values may be used in control strategies to predict the effect on a voltage profile that control actions will produce. The predicted change in voltage at each voltage measurement location is given by rearranging Eq. 5 to solve for ΔV, as shown in Eq. 6.

$$Δ V = \frac{{Q}_{rated}}{\sqrt{3} * {V}_{ll}} * X \qquad Eq . 6$$

An estimate of the voltage profile along transmission line 214 may enable more effective optimization of electrical circuits in support of system-level objectives. System-level objectives may include, for example, maintaining system stability, energy conservation, peak demand reduction, loss reduction, and the like.

Any or all of IEDs 220, 222, 224, and 270 may be configured to generate source impedance estimates and/or source impedance models. Further, source impedance estimates and/or source impedance models may be developed for any of the nodes associated with the plurality of voltage measurement devices.

According to some embodiments, in addition to voltage magnitude measurements, time-aligned voltage measurements may also be used to improve the estimation of the source impedance and/or generate source impedance models. Time-aligned voltage measurements may provide additional information regarding real and imaginary components of system 200. According to some embodiments, the use of time aligned voltage measurements may allow for the quantification of angle relationships a phasor diagram. Further, such quantification may facilitate the estimation of parameters relating to the real and complex impedance parameters of system 200. Further, using time-aligned measurements may improve the ability of a load model to predict a voltage profile when reactive power sourcing devices (e.g., capacitors 208 and 216) are connected to system 200.

After each control action, the resulting measured changes in voltage may be used to verify and improve a source impedance model. Accordingly, an iterative process may be used to develop and refine the source impedance model under a variety of conditions.

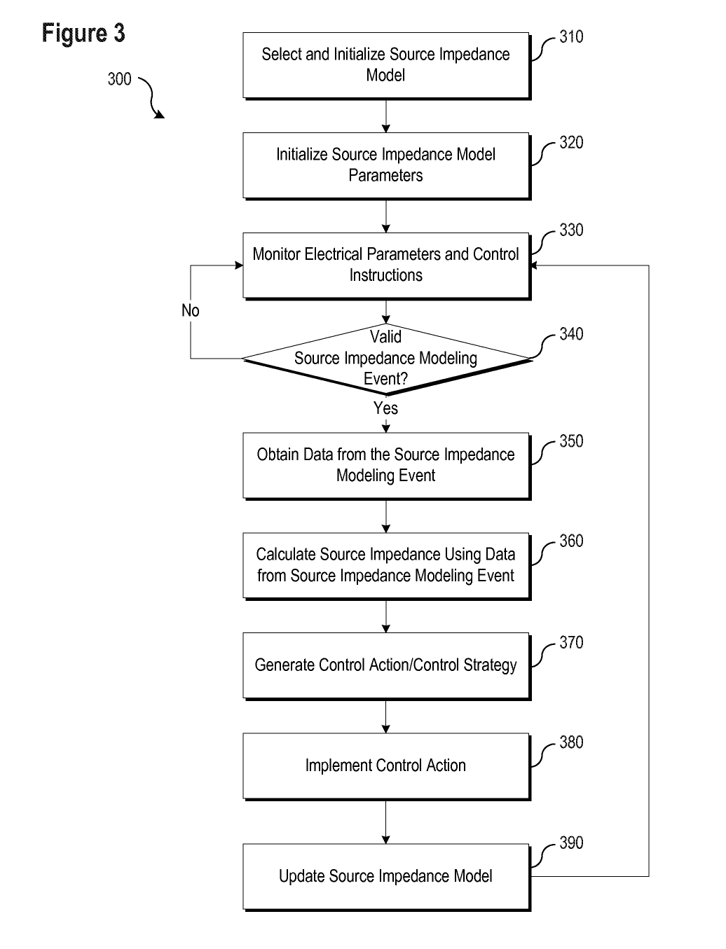

FIG. 3 illustrates a flow chart of one embodiment of a method 300 for estimating a source impedance value and creating a source impedance model based on data collected in connection with one or more modeling events. At 310, a source impedance model may be selected and initialized. A source impedance model may be selected in a variety of ways, including: user selection, simulations results, statistical information, preset defaults established by an equipment manufacturer, etc. At 320, source impedance model parameters appropriate to the selected source impedance model may be initialized. The initial values of source impedance model parameters may also be determined in a variety of ways, including: user selection, simulations results, statistical information, preset defaults established by an equipment manufacturer, etc.

Certain embodiments consistent with the present disclosure may not involve a source impedance model. Certain embodiments may calculate a source impedance model based on collected data without using such data in connection with a source impedance model. Accordingly, elements of a method 300 relating to creating a source impedance model may be omitted in such embodiments.

At 330, monitoring of electrical parameters and control instructions may begin. As described above, source impedance modeling events may occur in electric power distribution systems. According to various embodiments, source modeling events may be identified by monitoring electrical characteristics (e.g., changes in voltage magnitudes, changes in frequency, phase shifts) in an electric power distribution system and/or by monitoring control instructions issued to monitored equipment (e.g., an instruction to a breaker to connect a reactive power source to the electric power distribution system, an instruction to a voltage regulator to adjust a tap) that may cause a source impedance modeling event.

Changes in monitored electrical characteristics and/or certain types of control instructions may prompt an analysis at 340 to determine whether a valid source impedance modeling event has occurred. Determining whether a valid source impedance modeling event has occurred may involve comparing one or more electrical parameters to established criteria. The criteria defining a valid source impedance modeling event may be specified by a user or may have default criteria established by an equipment manufacturer. In certain embodiments an initial source impedance model may not be created until a valid modeling event has occurred. In such embodiments, elements 310 and 320 may follow element 340.

After identifying a valid modeling event at 340, data sets may be obtained relating to the modeling event at 350. The data sets may comprise a plurality of individual readings of electrical characteristics before, during, and/or after the modeling event. In one embodiment, each data set may contain a plurality of measurements (e.g., voltage magnitude measurements, frequency measurements, power measurements, and a time associated with each measurement). In certain embodiments, data sets may be collected from any number of IEDs in electrical communication with an electric power distribution system. Such IEDs may be distributed across a wide geographic area, and the data may be compared using a common time reference to sequence the data. Data associated with a source impedance modeling event may be transmitted via a network to one or more IEDs, control systems, or other devices configured to determine a source impedance or generate a source impedance model.

At 360, a source impedance value may be calculated using data from the source impedance modeling event. The source impedance value may be related to a particular location in an electric power distribution system, according to certain embodiments. Further, different source impedance values may be determined for a variety of points within the electric power distribution system. For example, according to some embodiments, a source impedance value may be determined for each of a plurality of nodes at which a voltage measurement is obtained.

At 370, a control action and/or control strategy may be generated based on the source impedance value. As described above, control actions and/or control strategies may be implemented in order to achieve a variety of objectives. Such objectives may include, but are not limited to, energy conservation, peak demand reduction, loss reduction, maintaining system stability, etc. In furtherance of these objectives, a variety of control actions may be implemented. Moreover, according to certain embodiments, a control strategy in an electric power distribution system may be refined over time to better achieve system-level objectives.

Certain embodiments consistent with the present disclosure involve creating a source impedance model that may be used to evaluate a plurality of contingencies. For example, using a source impedance model, a simulation may be run in order to determine whether a particular control action will result in a desired outcome. Given the complexity of electric power distribution systems, certain control actions may have unintended consequences. Accordingly, developing a model that takes into account various parameters and allows for an evaluation of contingencies may help to avoid implementing control actions that have undesirable results. In certain embodiments, a load impedance model may be a component of a system model including a variety of other models. For example, a system model may include a load dynamics model, a transmission system model, a stability model, etc. Each of the models may be used in conjunction to predict the response of the electric power distribution system to a particular control action or control strategy.

At 380, a control action may be implemented. As described in connection with 370, a modeled response to the control action may be determined prior to the implementation of the control action. In this way, the possibility of undesirable results may be reduced.

At 390, a source impedance model may be updated following the implementation of the control action. A variety of techniques may be used to update a source impedance model. For example, a predicted response to a control action implemented at 380 based on the source impedance module may be compared to the actual response of the system to the control action. A discrepancy between the predicted response and the actual response may be analyzed to tune the parameters of the source impedance model so that the model more accurately predicts the response of the physical system. In other words, at 390, adjustments to the source impedance model may be made to reduce errors between the predicted events and modeled events.

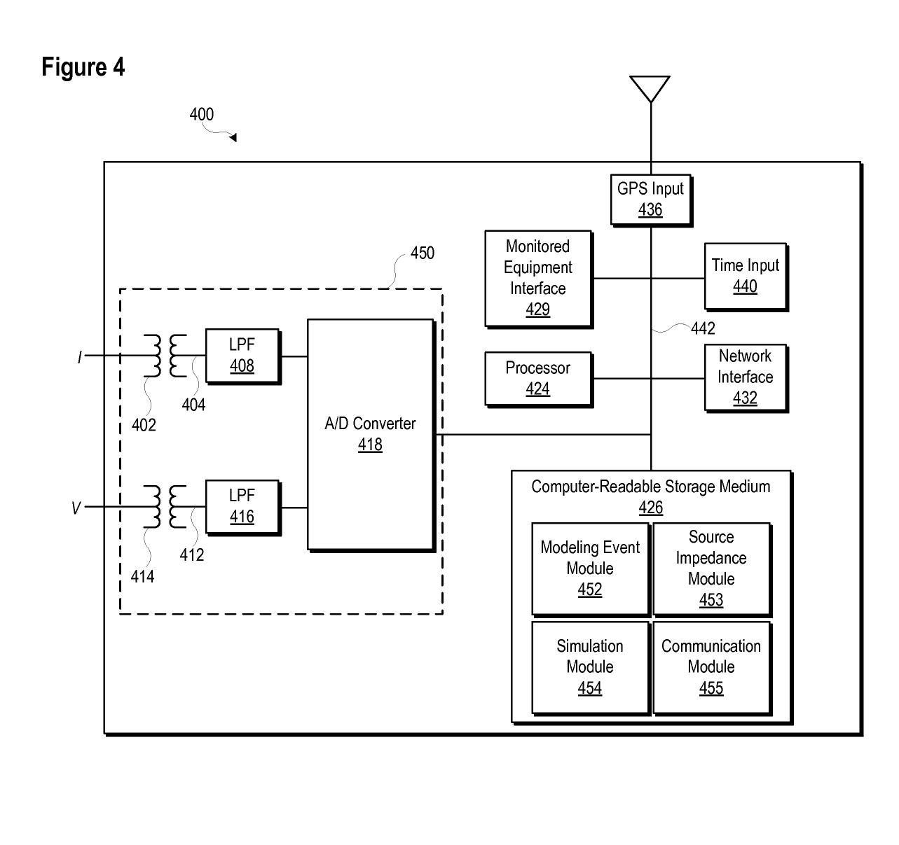

FIG. 4 illustrates an exemplary block diagram of an IED 400 configured to estimate a source impedance value and/or generate a source impedance mod& consistent with embodiments disclosed herein. IED 400 includes a network interface 432 configured to communicate with a data network. IED 400 also includes a time input 440, which may be used to receive a time signal. In certain embodiments, a common time reference may be received via network interface 432, and accordingly, a separate time input 440 and/or GPS input 436 would not be necessary. One such embodiment may employ the IEEE 1588 protocol. Alternatively, a GPS input 436 may be provided in addition to or instead of a time input 440.

A monitored equipment interface 429 may be configured to receive status information from, and issue control instructions to a piece of monitored equipment (e.g., a breaker, a tap changer, etc.).

A non-transitory computer-readable storage medium 426 may be the repository of one or more modules and/or executable instructions configured to implement any of the processes described herein. A data bus 442 may link monitored equipment interface 429, time input 440, network interface 432, GPS input 436, and computer-readable storage medium 426 to a processor 424.

Processor 424 may be configured to process communications received via network interface 432, time input 440, GPS input 436, and monitored equipment interface 429. Processor 424 may operate using any number of processing rates and architectures. Processor 424 may be configured to perform various algorithms and calculations described herein using computer executable instructions stored on computer-readable storage medium 426. Processor 424 may be embodied as a general purpose integrated circuit, an application specific integrated circuit, a field-programmable gate array, and other programmable logic devices.

In certain embodiments, IED 400 may include a sensor component 450. In the illustrated embodiment, sensor component 450 is configured to gather data directly from a conductor (not shown) using a current transformer 402 and/or a voltage transformer 414. Voltage transformer 414 may be configured to step-down the power system's voltage (V) to a secondary voltage waveform 412 having a magnitude that can be readily monitored and measured by IED 400. Similarly, current transformer 402 may be configured to proportionally step-down the power system's line current (I) to a secondary current waveform 404 having a magnitude that can be readily monitored and measured by IED 400. Low pass filters 408, 416 respectively filter the secondary current waveform 404 and the secondary voltage waveform 412. An analog-to-digital converter 418 may multiplex, sample and/or digitize the filtered waveforms to form corresponding digitized current and voltage signals.

As described above, certain embodiments may monitor the terminal voltage of one or more phases in electric power distribution system. Sensor component 450 may be configured to perform this task. According to other embodiments, sensor component 450 may be configured to monitor a wide range of characteristics associated with monitored equipment, including equipment status, temperature, frequency, pressure, density, infrared absorption, radio-frequency information, partial pressures, viscosity, speed, rotational velocity, mass, switch status, valve status, circuit breaker status, tap status, meter readings, and the like.

A/D converter 418 may be connected to processor 424 by way of a bus 442, through which digitized representations of current and voltage signals may be transmitted to processor 424 and/or stored in computer-readable storage medium 426. In various embodiments, the digitized current and voltage signals may be compared against criteria for identifying a source impedance modeling event.

A monitored equipment interface 429 may be configured to receive status information from, and issue control instructions to a piece of monitored equipment. Monitored equipment interface 429 may be in communication with a variety of types of equipment, such voltage regulators, breakers, reclosers, generators, etc. According to some embodiments, control instructions may also be issued via network interface 432. Control instructions issued via network interface 432 may be transmitted, for example, to other IEDs (not shown), which in turn may issue the control instruction to a piece of monitored equipment. Alternatively, the piece of monitored equipment may receive the control instruction directly via network interface 432.

Computer-readable storage medium 426 may be the repository of one or more functional modules and/or executable instructions configured to implement certain functions or implement certain methods described herein. Modeling event module 452 may be configured to identify conditions indicative of a valid modeling event. As described above, source modeling events may be identified by monitoring electrical characteristics (e.g., changes in voltage magnitudes, changes in frequency, phase shifts) in an electric power distribution system and/or by monitoring control instructions issued to monitored equipment (e.g., an instruction to a breaker to connect a reactive power source to the electric power distribution system, an instruction to a voltage regulator to adjust a tap). Modeling event module 452 may be configured to evaluate certain criteria to determine when a source impedance modeling event has occurred.

A source impedance module 453 may be configured to calculate a source impedance value based on measurements of electrical parameters. Source impedance module 453 may further be configured in certain embodiments to generate a source impedance model. Source impedance module 453 may be configured to generate parameters associated with the source impedance model that may be tuned over time to enable the source impedance model to more accurately predict the source impedance of the modeled system.

A simulation module 454 may be configured to conduct simulations involving the source impedance model under a variety of contingencies. For example, the impact of a particular control action may be assessed by simulating a response using the source impedance model under a particular set of conditions or contingencies. To the extent that the simulation shows that the control action results in a desirable outcome, the control action may be implemented; however, to the extent that the control action results in an undesirable outcome, an alternate control action may be explored. Simulation module 454 may further be configured to compare the results of a simulation involving a particular control action to actual results caused by implementing the particular control action in order to provide a feedback process that may improve the predictive power of the source impedance model.

Communication module 455 may facilitate communication between IED 400 and other IEDs (not shown) via network interface 432. In addition, communication module 455 may further facilitate communication with monitored equipment in communication with IED 400 via monitored equipment interface 429 or with monitored equipment in communication with IED 400 via network interface 432.

According to various embodiments, computer-readable storage medium 426 may comprise more or fewer functional modules than are shown in FIG. 4. Further, according to various embodiments, the functionality described in connection with functional modules 452-455 may be implemented in a variety of ways.

While specific embodiments and applications of the disclosure have been illustrated and described, the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

1. An intelligent electronic device (IED) configured to interface with an electric power distribution system, comprising:
a bus;
a communications interface in communication with the bus;
a processor in communication with the bus; and
a non-transitory computer-readable storage medium in communication with the bus, comprising:
software instructions executable on the processor that enable the IED to:
identify a first source impedance modeling event at a first node in the electric power distribution system;
receive a first plurality of measurements representing a first electrical condition at the first node prior to the first source impedance modeling event and subsequent to the first source impedance modeling event;
calculate a first source impedance value based on the first plurality of measurements at the first node;
generate a first control action based at least in part upon the first source impedance value and a control strategy; and
transmit the first control action via the communications interface.

2. The IED of claim 1, wherein the first source impedance modeling event comprises connection of a reactive power source to the electric power distribution system.

3. The IED of claim 2, wherein the reactive power source comprises a capacitor bank.

4. The IED of claim 1, wherein the software instructions further enable the IED to generate a first source impedance model based on the first plurality of measurements.

5. The IED of claim 4, wherein the software instructions further enable the IED to predict a voltage response at the first node based on a contingency using the first source impedance model.

6. The IED of claim 4, wherein the software instructions further enable the IED to generate a second control action based at least in part on the first source impedance model.

7. The IED of claim 1, wherein the software instructions further enable the IED to:
receive via the communications interface a second plurality of measurements representing a second electrical condition at a second node in the electric power distribution system prior to the first source impedance modeling event and subsequent to the first source impedance modeling event; and
calculate a second source impedance value based on the second plurality of measurements at the second node.

8. The IED of claim 1, wherein the first plurality of measurements further comprises an indication of a phase relationship between a plurality of time-aligned voltage measurements at the first node.

9. The IED of claim 1, wherein the software instructions further enable the IED to identify the first source impedance modeling event based on at least one criteria of an electrical parameter.

10. The IED of claim 9, wherein the criteria comprises one of a measured voltage magnitude and a measured phase relationship.

11. The IED of claim 1, wherein the control strategy comprises one of maintaining stability of the electric power distribution system, reducing energy consumption, peak demand reduction, and maintaining a power factor.

12. The IED of claim 1, wherein the communications interface comprises one of a monitored equipment interface and a data network interface.

13. The IED of claim 1, wherein the software instructions further enable the IED to:
store the first plurality of measurements;
identify a second source impedance modeling event;
receive a second plurality of measurements representing a second electrical condition at the first node prior to a second source impedance modeling event and subsequent to the second source impedance modeling event; and,
calculate a second source impedance value based on the first plurality of measurements and the second plurality of measurements at the first node.

14. A method for estimating a source impedance value, the method comprising:
identifying a first source impedance modeling event at a first node in an electric power distribution system;
receiving a first plurality of measurements representing a first electrical condition at the first node prior to the first source impedance modeling event and subsequent to the first source impedance modeling event;
calculating a first source impedance value based on the first plurality of measurements at the first node; and
generating a control action based at least in part upon the first source impedance value and a control strategy.

15. The method of claim 14, wherein the first source impedance modeling event comprises connecting a reactive power source to the electric power distribution system.

16. The method of claim 14, further comprising:
generating a first source impedance model based upon the first plurality of measurements.

17. The method of claim 16, further comprising:
predicting a response at the first node based upon a contingency using the first source impedance model.

18. The method of claim 16, further comprising:
generating a second control action based on the first source impedance model.

19. The method of claim 14, further comprising:
receiving a second plurality of measurements representing a second electrical condition at a second node in the electric power distribution system prior to the first source impedance modeling event and subsequent to the first source impedance modeling event; and
calculating a second source impedance value based on the second plurality of measurements at the second node.

20. The method of claim 14, further comprising:
identifying the first source impedance modeling based on at least one criteria.

21. A non-transitory computer-readable storage medium, comprising software instructions executable on a processor that cause the processor to:
identify a first source impedance modeling event at a first node in the electric power distribution system;
receive a first plurality of measurements representing a first electrical condition at the first node prior to the first source impedance modeling event and subsequent to the first source impedance modeling event;
calculate a first source impedance value based on the first plurality of measurements at the first node;
generate a first control action based at least in part upon the first source impedance value and a control strategy; and
transmit the first control action via the communications interface.
